(19) United States
(12) Patent Application Publication
(10) Pub. No.: US 2019/0232389 A1
(43) Pub. Date: Aug. 1, 2019

(54) METHOD AND DEVICE FOR MONITORING A TOOL CLAMPING SYSTEM OF A WORK SPINDLE OF A NUMERICALLY CONTROLLED MACHINE TOOL

(71) Applicant: DECKEL MAHO PFRONTEN GMBH, Pfronten (DE)

(72) Inventor: Rolf KETTEMER, Marktoberdorf (DE)

(73) Assignee: DECKEL MAHO PFRONTEN GMBH, Pfronten (DE)

(21) Appl. No.: 16/262,135

(22) Filed: Jan. 30, 2019

(30) Foreign Application Priority Data
Jan. 30, 2018 (DE) 10 2018 201 427.2

(51) Int. Cl. B23B 31/26

(52) U.S. Cl. CPC B23B 31/261; B23B 2260/128

(57) ABSTRACT

A method or device for monitoring a work spindle's tool clamping system of a numerically controlled machine tool with a control device controlling the processing of a workpiece with a tool clamped to the work spindle by a tool interface when a tool is clamped to the work spindle's tool interface holder by a tool interface, wherein the work spindle has a plurality of force sensors on a tool interface holder's bearing areas of the work spindle and force sensors' sensor values of the work spindle are provided on the control device with the tool clamped by means of the tool interface to the work spindle's tool interface holder, including monitoring the work spindle's tool clamping system when the tool is clamped by means of the tool interface to the work spindle's tool interface holder at the control device on the basis of a determined force distribution.

The present invention relates to a method and a device for monitoring a tool clamping system of a work spindle of a numerically controlled machine tool with a control device for controlling the processing of a workpiece by means of a tool clamped to the work spindle by means of a tool interface when a tool is clamped to the tool interface holder of the work spindle by means of a tool interface, wherein the work spindle has a plurality of force sensors on bearing areas of a tool interface holder of the work spindle and sensor values of the force sensors of the work spindle are provided on the control device when the tool is clamped by means of the tool interface on the tool interface holder of the work spindle.

### BACKGROUND

It is known in the prior art to monitor the tool clamping system of the work spindle of the machine tool on numerically controlled machine tools for processing a workpiece with a tool clamped by means of a tool interface to the work spindle when a tool is clamped by means of the tool interface to the tool interface holder of the work spindle.

In this connection, it is provided according to EP 2 829 859 A2 that the work spindle has a plurality of force sensors (e.g. strain gages or other force sensors) on bearing areas of a tool interface holder of the work spindle, so that sensor values of the force sensors of the work spindle can be provided on the control device of the machine tool when the tool is clamped by means of the tool interface on the tool interface holder of the work spindle.

In particular, EP 2 829 859 A2 shows a method for determining deformations of a geometric body or for measuring forces or moments acting on a geometric body by means of force or deformation measurement sensors if it is intended to specify by means of which a more accurate determination of deformations of the geometric body or a more accurate measurement of forces or moments acting thereon is made possible. For this purpose, it is proposed to arrange a plurality of force or deformation measuring sensors on the geometric body in at least two groups in such a way that a first group of the force or deformation sensors detects forces or deformations of the geometric body that are applied to the geometric body along a first spatial direction on the basis of a coordinate system stationary in relation to the geometric body and a second group of the force or deformation sensors detects forces or deformations of the geometric body that are applied to the geometric body along a second spatial direction on the basis of a coordinate system which is stationary in relation to the geometric body, said second spatial direction being independent of the first spatial direction, and that signal outputs of the force or deformation sensors are set in relation to one another for signal detection and evaluation and determination or evaluation of force or deformation components acting in different spatial directions.

It is also known e.g. according to EP 2 924 526 A1 to monitor operating parameters on the machine tool on the basis of a sensor configuration according to EP 2 829 859 A2. In particular, EP 2 924 526 A1 shows a method for setting and/or monitoring operating parameters of a workpiece processing machine which has a tool holder and member for moving a workpiece and the tool holder relative to each other at least along a first axis. The method according to the invention is distinguished in that, in the processing operation of the tool holder equipped with a tool and in the engagement of the tool with a workpiece, values for at least one of the following measured variables occurring on the tool during interaction between the tool and the workpiece and transmitted to the tool holder are recorded on the tool holder and are recorded for the course of the processing: a. an axial force acting in the direction parallel to the first axis, b. a torque applied with respect to the first axis or an axis parallel thereto, c. bending moments or bending moment components according to direction and amount, wherein the determined values for the at least one measured variable are used in order to carry out a setting of the operating parameters which is coordinated with regard to an extended service life of the tool used and at the same time a processing time which is shorter than a maximum processing time and/or in order to monitor the processing operation with regard to a reproducibility thereof and/or tool wear and/or a machine error of the workpiece processing machine.

An object of the present invention is to improve the monitoring of the tool clamping system of a work spindle before and during workpiece processing and, in particular, to make it more user-friendly and/or, during the processing operation, to be able to carry out processing in a way that is gentle on machines, tools and/or workpieces.

### SUMMARY

In order to solve the above problem, a method is provided for monitoring a tool clamping system of a work spindle of a numerically controlled machine tool according to claim 1, and a control device for controlling the processing of a workpiece with a tool clamped by means of a tool interface to a work spindle of a numerically controlled machine tool and for monitoring a tool clamping system of the work spindle of the machine tool according to claim 23, as well as a machine tool with such a control device and also a corresponding computer program product according to claim 24. Dependent claims relate to preferred embodiments.

According to one aspect, a method is provided for monitoring a tool clamping system of a work spindle of a numerically controlled machine tool with a control device for controlling the processing of a workpiece with a tool clamped to the work spindle by means of a tool interface when a tool is clamped to the tool interface holder of the work spindle by means of a tool interface.

Here, the work spindle is provided with a plurality of force sensors on bearing areas of a tool interface holder of the work spindle and sensor values of the force sensors of the work spindle are provided on the control device with the tool clamped by means of the tool interface to the tool interface holder of the work spindle.

It is also suggested that the method should comprise: Determining a force distribution at the bearing areas of the tool interface holder when the tool is clamped by means of the tool interface to the tool interface holder of the work spindle on the basis of the sensor values provided by the force sensors, and/or monitoring the tool clamping system of the work spindle when the tool is clamped by means of the tool interface to the tool interface holder of the work spindle at the control device on the basis of the force distribution determined, in particular with regard to the requirement to carry out safety control measures to protect against spindle damage, workpiece damage and/or tool damage during workpiece processing.

According to a preferred exemplary aspect, the method comprises: determining a pull-in force acting when the tool is clamped to the tool clamping system of the work spindle on the basis of the force distribution determined, in particular after clamping the tool.

According to a preferred exemplary aspect, the method comprises: comparing the determined pull-in force with one or more pull-in force limit values, and/or carrying out a safety control measure if it is determined that the determined pull-in force falls below at least one of the pull-in force limit values.

Implementing the safety control measure preferably comprises: outputting a visual and/or acoustic warning signal to an operator of the machine tool, slowing down or stopping a feed of one, a plurality of or all the feed axes of the machine tool, reducing the spindle speed of the work spindle or stopping the work spindle of the machine tool, controlling the feed axes of the machine tool to remove the tool away from the workpiece, and/or initiating an emergency stop at the machine tool.

According to a preferred exemplary aspect, the method comprises: setting or determining the one or more pull-in force limit values depending on the spindle speed, tool type, tool size, tool interface type and/or tool interface size.

According to a preferred exemplary aspect, the method comprises: outputting the determined pull-in force at a graphical user interface of the control device.

According to a preferred exemplary aspect, the method comprises: determining an axial force acting dynamically on the tool clamping system of the work spindle and/or on the tool during the processing of a workpiece with the tool clamped on the basis of the determined force distribution, in particular during the processing of a workpiece with the tool clamped.

According to a preferred exemplary aspect, the method comprises: comparing the determined axial force with one or more axial force limit values and/or carrying out a safety control measure if it is determined that the determined axial force exceeds at least one of the one or more axial force limit values.

According to a preferred exemplary aspect, the method comprises: setting or determining the one or more axial force limit values on the basis of the pull-in force, spindle speed, tool type, tool size, tool interface type and/or tool interface size.

According to a preferred exemplary aspect, the method comprises: setting or determining the one or more axial force limit values on the basis of the determined pull-in force.

According to a preferred exemplary aspect, the method comprises: outputting the determined axial force to a graphical user interface of the control device.

According to a preferred exemplary aspect, the method comprises: determining a radial torque dynamically acting on the tool clamping system of the work spindle and/or on the tool during the processing of a workpiece with the tool clamped, on the basis of the determined force distribution, in particular during the processing of a workpiece with the tool clamped.

According to a preferred exemplary aspect, the method comprises: comparing the determined radial torque with one or more radial torque limit values, and/or carrying out a safety control measure if it is determined that the determined radial torque exceeds at least one of the one or more radial torque limit values.

According to a preferred exemplary aspect, the method comprises: setting or determining the one or more radial torque limit values on the basis of the pull-in force, spindle speed, tool type, tool size, tool interface type and/or tool interface size.

According to a preferred exemplary aspect, the method comprises: setting or determining the one or more radial torque limit values on the basis of the determined pull-in force or on the basis of a critical bending moment and/or lift-off torque corresponding to the determined pull-in force, in particular on the basis of the tool interface type and/or tool interface size.

According to a preferred exemplary aspect, the method comprises: outputting the determined radial torque to a graphical user interface of the control device.

According to a preferred exemplary aspect, the conduction of the safety control measure comprises: outputting a visual and/or acoustic warning signal to a machine tool operator, slowing down or stopping a feed of one, a plurality of or all the feed axes of the machine tool, reducing the spindle speed of the work spindle or stopping the work spindle of the machine tool, controlling the feed axes of the machine tool to remove the tool away from the workpiece, and/or initiating an emergency stop at the machine tool.

According to a preferred exemplary aspect, after clamping the tool at the tool interface holder of the work spindle, it is determined on the basis of the force distribution determined whether interfering objects influencing the clamping situation, in particular dirt or chips, are present between bearing areas of the tool interface holder and corresponding bearing areas of the tool interface of the clamped tool.

According to a preferred exemplary aspect, the method comprises: determining a position of one or more interfering objects which influence the clamping situation and are present between bearing areas of the tool interface holder and corresponding bearing areas of the tool interface of the clamped tool on the basis of the determined force distribution, if it is determined on the basis of the determined force distribution that one or more interfering objects which influence the clamping situation are present between bearing areas of the tool interface holder and corresponding bearing areas of the tool interface of the clamped tool.

According to a preferred exemplary aspect, the bearing areas of the tool interface of the clamped tool are divided into sectors with respect to a reference point of the tool interface, wherein one or more sectors of the bearing areas of the tool interface in which interfering objects are present are determined when determining the position of one or more existing interfering objects on the basis of the determined force distribution.

According to a preferred exemplary aspect, the sectors of the bearing areas of the tool interface comprise a plurality of sectors on a flat contact area of the tool interface and/or the sectors of the bearing areas of the tool interface comprise a plurality of sectors on a conical contact area of the tool interface.

According to a preferred exemplary aspect, the control device is designed to output position data indicating determined positions of one or more interfering objects present between bearing areas of the tool interface holder and corresponding bearing areas of the tool interface of the clamped tool.

According to a preferred exemplary aspect, the method comprises: outputting the determined positions of the one or more existing interfering objects to a graphical user interface of the control device.

Another exemplary aspect proposes a control device to control the processing of a workpiece by means of a tool clamped by a tool interface to a work spindle of a numerically controlled machine tool and to monitor a tool clamping system of the work spindle of the machine tool when a tool is clamped by a tool interface to the tool interface holder of the work spindle, the work spindle having a plurality of force sensors on bearing areas of a tool interface holder of the work spindle, and sensor values of the force sensors of the work spindle being provided on the control device with the tool clamped by means of the tool interface to the tool interface holder of the work spindle, and the control device being adapted: to determine a force distribution on the bearing areas of the tool interface holder when the tool is clamped by means of the tool interface to the tool interface holder of the work spindle on the basis of the sensor values provided by the force sensors, and to monitor the tool clamping system of the work spindle when the tool is clamped by means of the tool interface to the tool interface holder of the work spindle at the control device on the basis of the force distribution determined, in particular with regard to the requirement to carry out safety control measures to protect against spindle damage, workpiece damage and/or tool damage during workpiece processing.

According to another exemplary aspect, a computer program product is proposed, comprising commands which cause the control device to carry out a method according to one of the foregoing aspects, when the program is executed by a computer of a control device for controlling a processing operation of a workpiece with a tool clamped by means of a tool interface to a work spindle of a numerically controlled machine tool and for monitoring a tool clamping system of the work spindle of the machine tool when a tool is clamped by means of a tool interface to the tool interface holder of the work spindle, the work spindle having a plurality of force sensors on bearing areas of a tool interface holder of the work spindle, and sensor values of the force sensors of the work spindle being provided on the control device when the tool is clamped by means of the tool interface to the tool interface holder of the work spindle.

### BRIEF DESCRIPTION OF THE DRAWINGS

FIG. 1 shows a schematic exemplary embodiment of a numerically controlled machine tool.

FIG. 2 shows a schematic exemplary view of the tool clamping on the work spindle of the machine tool.

FIG. 3 shows an exemplary flow chart of an exemplary method for monitoring a tool clamping system of the work spindle of the machine tool according to an embodiment of the present invention.

### DETAILED DESCRIPTION

In the following, preferred embodiments of the present invention are described in detail with reference to the attached drawings. However, the present invention is not limited to the embodiments described. The present invention is defined by the scope of the claims. The same or equal features of the embodiments are indicated in the drawings with the same reference signs.

FIG. 1 shows a schematic exemplary design of a numerically controlled machine tool 100.

The machine tool 100 comprises, as an example, a machine bed 110 on which an exemplary workpiece clamping table 150 is arranged, which can comprise one or more slides which can be moved linearly on the machine bed 110 and/or one or more rotationally drivable rotary axes or swivel axes, and on which a workpiece WS can be clamped.

The machine tool 100 also includes, for example, a machine stand 120, on which a spindle carrier 130 with a work spindle 140 is arranged, which can comprise one or more slides that can be moved linearly on the machine stand 120 and/or can have one or more rotationally drivable rotary axes or swivel axes. As an example, the machine tool 100 can be designed as a 5-axis or 6-axis machine tool.

A tool WZ, e.g. a milling or drilling tool, is clamped, for example, by means of a tool interface 200 on the spindle 140. The tool interface 200 can be designed as a hollow shank taper, steep taper, polygonal shank taper, Morse taper or as a tool interface known in other ways.

The machine tool 100 also comprises a computerized control device 160 with a screen 161 (possibly designed as a touch monitor) and with an input field 162 for entering control commands or operating commands of an operator, e.g. via a keyboard, computer mouse, knobs or rotary knobs. Furthermore, the control device 160 comprises a data processing apparatus 163 for storing data and for carrying out computer-assisted methods, e.g. by means of a processor.

The control device 160 is set up to control a relative movement of the clamped tool WZ relative to the clamped workpiece WS, if necessary on the basis of NC control data, and to control actuators of the machine tool (e.g. axis drives) and to read out sensor signals of the sensors of the machine tool 100.

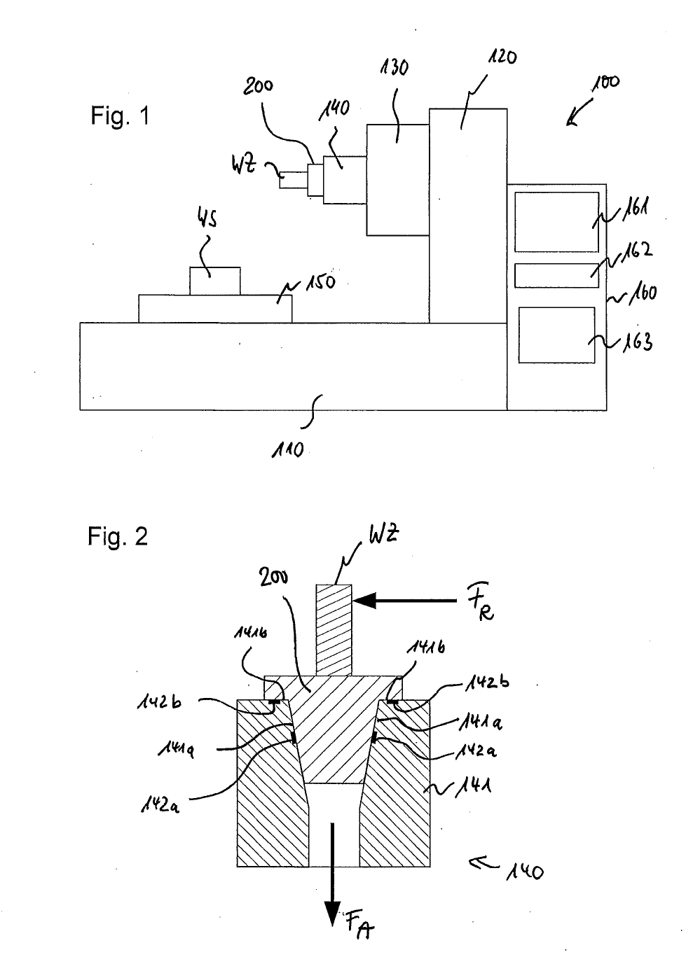

FIG. 2 shows a schematic exemplary view of the tool clamping on the work spindle of the machine tool.

The work spindle 140 comprises a tool interface holder 141, on which a tool interface 200 is clamped, wherein a tool WZ is attached or fastened to the tool interface 200.

The bearing areas of the tool interface holder 141, on which bearing areas of the tool interface 200 rest in the clamped state, comprise a plurality of force sensors 142a and 142b, which can be designed as strain gages, for example.

Force sensors 142b are arranged on one section of the flat contact 141b of the bearing areas of the tool interface holder 141 and force sensors 142a are arranged on one section of the cone contact area 141a of the bearing areas of the tool interface holder 141. Force sensors 142a and 142b can be used to determine force distribution on bearing areas of the tool interface 200 in the clamped state, in particular in the region of the flat contact and the cone contact area of the tool interface 200.

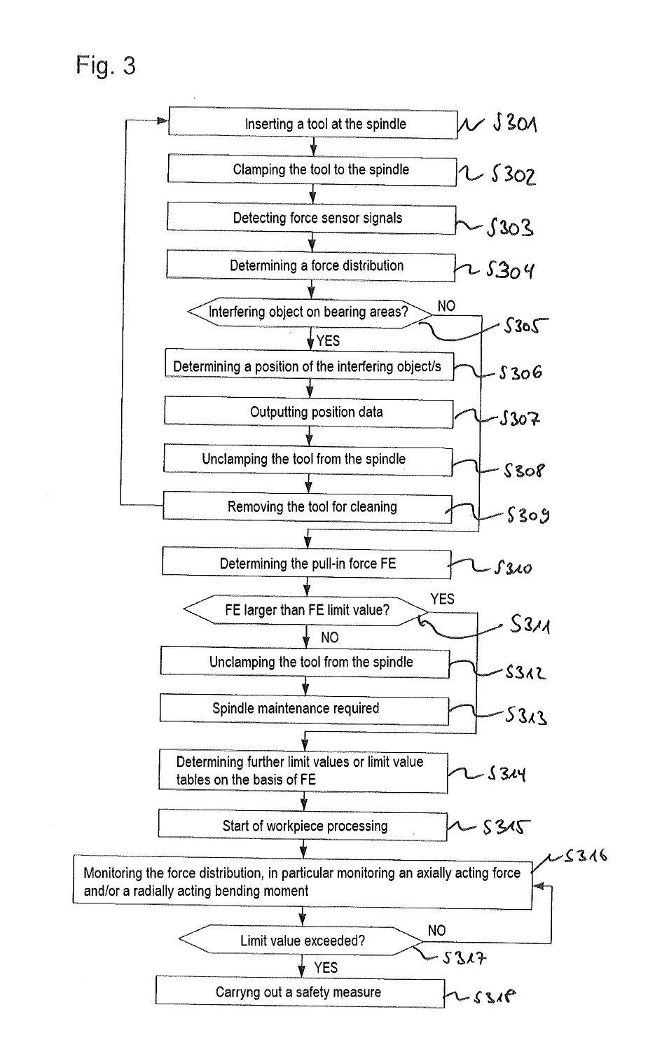

FIG. 3 shows an exemplary flow chart of an exemplary method for monitoring a tool clamping system of the work spindle of the machine tool according to an embodiment of the present invention.

In step S301, a tool WS is inserted into a tool interface holder 141 of the work spindle 140 of the machine tool 100 by means of the tool interface 200 and then clamped in step S302 to the work spindle 140.

In step S303, the sensor signals of the force sensors 142a and 142b are read out at the tool interface holder 141 of the work spindle 140 or made available at the control device 160.

In step S304, a force distribution is determined at the control device 160 on the basis of the sensor signals of the plurality of force sensors 142a and 142b at the tool interface holder 141 of the work spindle 140, on the basis of which forces that act axially (i.e. in the spindle axis direction) and radially acting forces or torques can be determined.

It is also advantageously possible to check the determined force distribution for any asymmetries and thereby draw conclusions as to whether the tool interface 200 is correctly clamped to the tool interface holder 141 of the work spindle 140, or whether, after clamping the tool WZ with the tool interface on the tool interface holder 141 of the work spindle 140 between the bearing areas 141a and 141b of the tool interface holder 141 and corresponding bearing areas of the tool interface 200 of the clamped tool WZ, there are interfering objects, in particular chips or other contamination, influencing or disturbing the clamping situation.

In the exemplary step S305, it is determined on the basis of the force distribution determined in step S304 whether, for example, on the basis of a determined asymmetry, it can be detected that after clamping the tool WZ between the bearing areas 141a and 141b of the tool interface holder 141 and the corresponding bearing areas of the tool interface 200, interfering objects are possibly present, i.e. in particular chips or other contamination. Here it is possible to detect chips or contamination up to the range with interfering object sizes of less than or equal to 10 μm.

If step S305 is YES, the position of one or more interfering objects between the contact areas 141a and 141b of the tool interface holder 141 and the corresponding bearing areas of the tool interface 200 is determined on the basis of the force distribution determined in step S304.

The method thus comprises step S306 of determining a position of one or more interfering objects which influence the clamping situation and are present between bearing areas of the tool interface holder 141 and corresponding bearing areas of the tool interface 200 of the clamped tool WZ on the basis of the determined force distribution, if it is determined on the basis of the determined force distribution that one or more interfering objects which influence the clamping situation are present between bearing areas of the tool interface holder and corresponding bearing areas of the tool interface of the clamped tool (step S305 is YES).

After determining the positions of the detected interfering objects, the control device is arranged to store the determined position(s) of the detected interfering objects in position data and to output the position data (step S307).

Furthermore, in step S308 the tool WZ or the tool interface 200 can be unclamped from the tool interface holder 141 of the work spindle 140 and removed for cleaning in step S309. This can be done manually by the operator or by a tool changing device of the machine tool 100.

After cleaning the tool interface 200 and/or the tool interface holder 141 or the corresponding bearing surfaces, the tool can be re-used on the spindle 140, e.g. to carry out steps S301 to S305 again after cleaning the tool interface 200 and/or the tool interface holder 141.

To make it easier for the operator to clean the tool interface 200 and/or the tool interface holder 141, the position data can be output, e.g. also by visual display on the display device (screen) 161 of the control device 160, in order to indicate to the operator the determined position(s) of the detected interfering objects.

In preferred embodiments, the bearing areas of the tool interface 200 of the clamped tool WZ can be divided for this purpose, into sectors with respect to a reference point of the tool interface 200, wherein when determining the position(s) of the one or more interfering objects present on the basis of the determined force distribution in step S306, one or more sectors of the bearing areas of the tool interface are determined in which the interfering objects are present.

Consequently, a graphical user interface of the control device 160, for example on the monitor 161, can indicate to the operator in which sector(s) of the bearing areas of the tool interface 200 of the clamped tool WZ interfering objects are present, so that the operator can clean this/these sector/s or examine them more efficiently for the interfering objects.

According to a preferred exemplary aspect, the sectors of the bearing areas of the tool interface here include several sectors on a flat contact area of the tool interface and/or the sectors of the bearing areas of the tool interface include a plurality of sectors on a conical contact area of the tool interface.

The sectors are here preferably indicated in relation to a reference point of the tool interface 200 identifiable by the operator. Such a reference point can be visibly arranged on the tool interface 200, e.g. by color marking or shaping or elevations (e.g. grooves or elevations). In the case of some tool interface types, such reference points may already exist and in the case of a groove, for example, the reference groove is known which is also known by the expert as the “German corner”.

If steps S301 to S305 are repeated after cleaning, or if there are no interfering objects, also directly, if step S305 is NO, an axially (i.e. in the spindle axis direction) acting pull-in force FE is measured or determined on the basis of the force distribution determined in step S304; step S310.

In step S311, the control device 160 determines whether the determined pull-in force FE falls below a pull-in force limit value, and if it is determined that the pull-in force FE falls below the pull-in force limit value (step S311 is NO), the tool WZ or the tool interface 200 is unclamped at the spindle 140 (and removed, if necessary, e.g. analogous to step S309) in order to possibly carry out spindle maintenance. For this purpose, the graphical user interface of the control device 160 can indicate to an operator that spindle maintenance is necessary, since the required pull-in force, which ensures the processing safety, can no longer be achieved on the clamping system when clamping the tool.

If step S311 shows that the determined pull-in force FE is greater than the pull-in force limit value (step S311 is YES), one or more further limit values are determined in step S314 as an example, in particular limit values for maximum bending moments occurring during processing (radially acting torques) and/or for axially acting forces occurring during processing (i.e. in the spindle axis direction).

This can also be done on the basis of limit value tables stored in a memory of the control device depending on various parameters.

Here, limit values can also be based on various specifications, e.g. limit values for maximum bending moments occurring during processing (radially acting torques) and/or for axially acting forces occurring during processing (i.e. in the spindle axis direction) under the condition of avoiding excessive spindle loads or spindle bearing loads on the spindle to avoid excessive wear or damage to the spindle or spindle bearings.

Furthermore, it is possible to set limit values for maximum bending moments occurring during processing (radially acting torques) and/or for axially acting forces occurring during processing (i.e. in the spindle axis direction) which are adapted to the specific tool and/or specific tool interface, i.e. e.g. to the type or size of the corresponding tool or tool interface, under the condition of avoiding excessive bending moments and/or axial forces on the tool in order to avoid damage to the tool (e.g. cutting edge breakage or tool breakage), and/or also to avoid excessive radial moments on the tool interface, in particular to keep the radially acting bending moments below the critical bending moments or lifting moments of the tool interface, in order to prevent the clamped tool interface from lifting off from the flat contacts of the tool interface support. In particular, one or more limit values of the maximum bending moments/radial moments occurring can preferably be set on the basis of the size and/or type of tool interface and/or preferably according to the pull-in force FE determined in step S310, in particular since different tool interfaces have different critical bending moments or different lifting moments at different sizes and different pull-in forces.

Based on investigations, it has been suggested that processing operations should only be carried out with pull-in forces above 18 kN. However, for the tool interface HSK (hollow shank cone) with size HSK 63, for example, the lift-off torque is about 450 NM at a pull-in force of 18 kN and the lift-off torque is about 540 NM at a pull-in force of 24 kN, so that higher bending moments are also possible at higher pull-in forces and higher radial torque limit values can be set as compared to lower pull-in forces. This remains qualitatively correct for other tool interface sizes, but at different values. For the HSK tool interface (hollow shank taper) with size HSK 100 and a pull-in force of 40 kN, the lift-off torque is about 1120 NM and for a pull-in force of 55 kN, the lift-off torque is about 1400 NM. Consequently, limit values for radial torques are preferably set on the basis of the tool interface used and its size, but is still preferred on the basis of the determined pull-in force FE.

Different limit values can be specified here for certain tools, for certain tool interfaces or their sizes, which can also lie at different values and can be monitored independently at the same time during the processing of the workpiece, if necessary also with different stored safety measures, which can/should be executed automatically when the respective limit value is exceeded. Limit values can also be readjusted manually by the operator, e.g. by adapting limit values displayed on the graphical user interface (suggested, if necessary), or also by selecting appropriate safety measures to be carried out or even programming them himself.

For example, it is possible to pre-store the respective assignment data for each tool interface type and each interface size (e.g. as a look-up table), which indicate the critical bending moment or lift-off moment on the basis of the pull-in force and, if necessary, a matching (smaller or considerably smaller) radial moment limit value, which can be further adjusted by the operator, if necessary.

Further limit values can also be specified or set to protect the spindle and/or spindle bearings, or also to protect the workpiece.

Any safety measures to be carried out appropriately by the control device when the limit values are exceeded can include e.g. the following safety measures:
outputting a visual and/or acoustic warning signal to an operator of the machine tool, e.g. via the graphical user interface;
slowing down and/or stopping a feed of one, a plurality of or all the feed axes of the machine tool;
reducing the spindle speed of the work spindle and/or stopping the work spindle of the machine tool;
controlling the feed axes of the machine tool to remove the tool away from the workpiece; and/or
initiating an emergency stop at the machine tool.

After determining the appropriate limit values, if necessary also according to the operator's specifications or settings, or even on the basis of limit values previously determined in test operations (so-called teach-in), workpiece processing is started in step S315.

The force distribution determined can be monitored by continuous or repeated retrieval of the sensor signals from the force sensors and determination or monitoring of the force distribution of the axially acting force or the radially acting bending moments; in step S316.

If the radial bending moments or the axially acting force exceeds one of the corresponding limit values (step S317 is YES), the control device will automatically carry out the corresponding safety measure assigned to the limit value or parameter to protect the spindle, tool and/or workpiece.

The limit values can here also be dynamically adjusted according to any specified limit value tables or limit value tables on the basis of the feed rate or spindle speed, e.g. by higher limit values as the speeds increase, etc.

In order to monitor the accuracy of the determination of the dynamically occurring axial forces when processing the workpiece, the force measured in the axial direction can be calibrated to zero or reset after determining the pull-in force FE, in order to be able to measure forces acting axially beyond the pull-in force with higher accuracy and to be able to display them to the operator directly as additionally occurring axial force.

The present invention therefore relates to an advantageous dynamic monitoring of the radial torques or axial forces on the clamping system of the spindle of the machine tool during workpiece processing and advantageously enables the dynamically adapted, possibly optimally preset limit value monitoring of the parameters to avoid damage to the spindle, spindle bearing, tools, tool interfaces and workpieces, depending on tool-specific, tool interface-specific, workpiece-specific conditions and conditions that are dependent on the spindle state.

1. A method for monitoring a tool clamping system of a work spindle of a numerically controlled machine tool having a control device for controlling the processing of a workpiece with a tool clamped to the work spindle by means of a tool interface when a tool is clamped to the tool interface holder of the work spindle by means of a tool interface,
wherein the work spindle has a plurality of force sensors on bearing areas of a tool interface holder of the work spindle and sensor values of the force sensors of the work spindle are provided on the control device when the tool is clamped by means of the tool interface to the tool interface holder of the work spindle,
the method comprising:
determining a force distribution at the contact areas of the tool interface holder when the tool is clamped by means of the tool interface to the tool interface holder of the work spindle on the basis of the sensor values provided by the force sensors, and
monitoring the tool clamping system of the work spindle when the tool is clamped by means of the tool interface to the tool interface holder of the work spindle on the control device on the basis of the force distribution determined with regard to the requirement to carry out safety control measures to protect against spindle damage, workpiece damage and/or tool damage during the processing of the workpiece.

2. The method according to claim 1, wherein
determining a pull-in force acting on the tool clamping system of the work spindle when the tool is clamped in place on the basis of the force distribution determined.

3. The method according to claim 2, wherein
comparing the determined pull-in force with one or more pull-in force limit values, and
carrying out a safety control measure if it is determined that the determined pull-in force is below at least one of the pull-in force limit values.

4. The method according to claim 3, wherein
setting or determining one or more pull-in force limit values on the basis of spindle speed, tool type, tool size, tool interface type and/or tool interface size.

5. The method according to claim 2, wherein
outputting the determined pull-in force at a graphical user interface of the control device.

6. The method according to claim 1, wherein
determining an axial force dynamically acting, during the processing of a workpiece with the clamped tool, on the tool clamping system of the work spindle and/or on the tool on the basis of the determined force distribution.

7. The method according to claim 6, wherein
comparing the determined axial force with one or more axial force limit values, and
carrying out a safety control measure if it is determined that the determined axial force exceeds at least one of the one or more axial force limit values.

8. The method according to claim 7, wherein
setting or determining one or more axial force limit values on the basis of the pull-in force, spindle speed, tool type, tool size, tool interface type and/or tool interface size.

9. The method according to claim 7, wherein
determining a pull-in force acting on the tool clamping system of the work spindle when the tool is clamped in place on the basis of the force distribution determined, and
setting or determining one or more axial force limit values on the basis of the determined pull-in force.

10. The method according to claim 7, wherein
outputting the determined axial force to a graphical user interface of the control device.

11. The method according to claim 1, wherein
determining a radial torque which acts dynamically during the processing of a workpiece with the clamped tool on the tool clamping system of the work spindle and/or on the tool on the basis of the determined force distribution, during the processing of a workpiece with the clamped tool.

12. The method according to claim 11, wherein
comparing the determined radial torque with one or more radial torque limit values, and
carrying out a safety control measure if it is determined that the determined radial torque exceeds at least one of the one or more radial torque limit values.

13. The method according to claim 12, wherein
setting or determining the one or more radial torque limit values on the basis of the pull-in force, spindle speed, tool type, tool size, tool interface type and/or tool interface size.

14. The method according to claim 12, wherein
determining a pull-in force acting on the tool clamping system of the work spindle when the tool is clamped in place on the basis of the force distribution determined, and
setting or determining the one or more radial torque limit values on the basis of the determined pull-in force or on the basis of a critical bending moment and/or lift-off torque corresponding to the determined pull-in force.

15. The method according to claim 11, wherein
outputting the determined radial torque at a graphical user interface of the control device.

16. The method according to claim 3, wherein
the conduction of the safety control measure comprises:
outputting a visual and/or acoustic warning signal to an operator of the machine tool,
slowing down or stopping a feed of one, a plurality of or all the feed axes of the machine tool,
reducing the spindle speed of the work spindle or stopping the work spindles of the machine tool,
controlling the feed axes of the machine tool to remove the tool away from the workpiece, and/or
initiating an emergency stop at the machine tool.

17. The method according to claim 1, wherein
after clamping the tool at the tool interface holder of the work spindle, it is determined on the basis of the force distribution determined whether there are any interfering objects influencing the clamping situation between the bearing areas of the tool interface holder and the corresponding bearing areas of the tool interface of the clamped tool.

18. The method according to claim 1, wherein
determining a position of one or more interfering objects which influence the clamping situation and are present between bearing areas of the tool interface holder and corresponding bearing areas of the tool interface of the clamped tool on the basis of the determined force distribution, if it is determined on the basis of the determined force distribution that one or more interfering objects which influence the clamping situation are present between bearing areas of the tool interface holder and corresponding bearing areas of the tool interface of the clamped tool.

19. The method according to claim 18, wherein
the bearing areas of the tool interface of the clamped tool are divided into sectors with respect to a reference point of the tool interface,
wherein, in determining the position of the one or more interfering objects present on the basis of the force distribution determined, one or more sectors of the bearing areas of the tool interface are determined in which interfering objects are present.

20. The method according to claim 19, wherein
the sectors of the bearing areas of the tool interface comprise a plurality of sectors on a flat contact area of the tool interface, and/or
the sectors of the bearing areas of the tool interface comprise a plurality of sectors on a cone contact area of the tool interface.

21. The method according to claim 18, wherein
the control device is arranged to output position data indicating determined positions of one or more interfering objects present between bearing areas of the tool interface holder and corresponding bearing areas of the tool interface of the clamped tool.

22. The method according to claim 18, wherein
outputting the determined positions of the one or more present interfering objects to a graphical user interface of the control device.

23. A control device for controlling the processing of a workpiece with a tool clamped by means of a tool interface to a work spindle of a numerically controlled machine tool and for monitoring a tool clamping system of the work spindle of the machine tool when a tool is clamped by means of a tool interface to the tool interface holder of the work spindle, wherein the work spindle comprises a plurality of force sensors on bearing areas of a tool interface holder of the work spindle and sensor values of the force sensors of the work spindle are provided at the control device when the tool is clamped by means of the tool interface at the tool interface holder of the work spindle, the control device being configured:
to determine a force distribution at the bearing areas of the tool interface holder when the tool is clamped by means of the tool interface to the tool interface holder of the work spindle on the basis of the sensor values provided by the force sensors, and
to monitor the tool clamping system of the work spindle when the tool is clamped by means of the tool interface to the tool interface holder of the work spindle on the control device on the basis of the force distribution determined with regard to the requirement to carry out safety control measures to protect against spindle damage, workpiece damage and/or tool damage during the processing of the workpiece.

24. A computer program product comprising commands which cause the control device to carry out a method according to claim 1, when the program is executed by a computer of a control device for controlling the processing of a workpiece when a tool is clamped by means of a tool interface to a work spindle of a numerically controlled machine tool and for monitoring a tool clamping system of the work spindle of the machine tool when a tool is clamped by means of a tool interface to the tool interface holder of the work spindle, wherein the work spindle comprises a plurality of force sensors on bearing areas of a tool interface holder of the work spindle, and sensor values of the force sensors of the work spindle are provided on the control device when the tool is clamped by means of the tool interface to the tool interface holder of the work spindle.
